(19) United States
(12) Patent Application Publication
(10) Pub. No.: US 2004/0199683 A1
(43) Pub. Date: Oct. 7, 2004

(54) Admission control system for home video servers

(76) Inventor: Charles August Asmuth, Princeton, NJ (US)

Correspondence Address: Joseph S Tripoli, Thomson Multimedia Licensing Inc, Suite # 2, Two Independance Way, Princeton, NJ, 08543-5312, US

(21) Appl. No.: 10/493,764

(22) PCT Filed: Oct. 31, 2002
(86) PCT No.: PCT/US02/34935

Related U.S. Application Data
(60) Provisional application No. 60/335,511, filed on Oct. 31, 2001.

(51) Int. Cl. G06F 3/00

(52) U.S. Cl. 710/52

(57) ABSTRACT

An admission control system includes a storage device, and a buffer memory interconnected to the storage device. An admission controller, interconnected to the buffer memory, includes means for measuring parameters pertaining to interactions between the storage device and the buffer memory, and means for controlling data transfers between the storage device and the buffer memory in response to at least some of the parameters being measured.

### FIELD OF THE INVENTION

The present invention relates generally to the transmission of digital data, and more particularly to determining whether a request to add an additional data stream to a currently operating set of transmission data streams may be honored in a digital data transmission system.

### BACKGROUND OF THE INVENTION

Data transmission systems transmit digital data from one point to another. This digital data can simultaneously include several respectively different streams of data, each representing a different signal. When the data transmission system is transmitting a plurality of data streams, and a request is received to include a new data stream, a decision must be made whether the data transmission system has the capacity to include the requested new data stream or not. There are many parameters, connections and circuits involved in the complete transmission of data from a data source to a data sink and all must have the capacity to handle the data transmission.

In one embodiment, these streams of data represent video and/or audio signals. The video and/or audio data streams are usually stored on a mass storage device such as a magnetic disk or hard drive. More specifically, a video and/or audio data stream may be either received from the transmission system and stored on the mass storage device (recording), or retrieved from the mass storage device and transmitted over the transmission system (playback). Such a system is often termed a multimedia system. As described before, there are many connections in a transmission system, such as a multimedia system. One such connection is between the mass storage device and the remainder of the transmission system.

In modern multimedia systems the large amounts of data representing the video and/or audio signals are often stored in the mass storage device as blocks of data, each block consisting of a series of bits. Because the mass storage device requires time between accessing successive blocks containing the desired data stream, data communications with the mass storage device consists of transferring successive bursts of data at a relatively high data rate (R in the remainder of this application) separated by the latency times (I in the remainder of the application), when the disk drive is repositioning to provide data representing the next data stream, during which no data is transferred. When the video data is transmitted in real time the data for each successive video frame must be available when needed at the receiving location. This means that a more constant transmission rate (r in the remainder of this application) is required over the transmission media without the bursts separated by latency times inherent in the mass storage device.

In order to allow data to be transmitted at the relatively constant transmission rate over the transmission medium while allowing data to be transferred to or from the mass storage device in bursts, a temporary memory area known as buffer memory is coupled between the mass storage device and the transmission medium. This may be a separate dedicated memory device, or may be a portion of the main memory of a processor, which controls access to the mass storage device, allocated for use as a buffer. This buffer is often visualized as a bucket which is filled by a data source and emptied by a data sink. For example, during playback, the buffer (bucket) is filled in bursts by data from the disk, and emptied at the constant data rate into the transmission medium, and during recording is filled at the constant data rate by the transmission medium and emptied in bursts onto the disk.

One skilled in the art understands that the size of the buffer memory must be sufficiently large to hold data for all the data streams being transferred. That is, if the buffer memory is sufficiently large, then all the data streams may be transmitted without either overflowing the buffer memory or allowing the buffer memory to completely empty. The inventor has realized that whenever a request to transmit a new data stream is received, the parameters of the current transmission system, and in particular the requested constant transmission rate r, the burst rate R of the disk, the latency time I of the disk, and the size of the buffer (B in the remainder of this application) must be evaluated to determine if the new data stream may be successfully transmitted. If so, then that data stream is admitted into the data transmission system, otherwise, it is not admitted.

Numerous methods exist which address the problem of buffer and I/O optimization. For example, U.S. Pat. No. 5,870,551 entitled LOOKAHEAD BUFFER REPLACEMENT METHOD USING RATIO OF CLIENTS ACCESS ORDER OFFSETS AND BUFFER DATA BLOCK OFFSETS, issued to Ozden et al, discloses a method of determining or estimating the future access of each data buffer in a buffer memory. After an analysis is performed for each data block in the buffer, the data block with the lowest probable future access is allocated to be replaced with new data.

U.S. Pat. No. 5,566,208, entitled ENCODER BUFFER HAVING AN EFFECTIVE SIZE WHICH VARIES AUTOMATICALLY WITH THE CHANNEL BIT RATE, issued to Balakrishnan, discloses a video transmission system in which the size of the buffer is increased with an increasing transmission rate. The buffer size is maintained at RΔT(1−m₁)−M, where R is the average transmission rate of the variable rate video signal, ΔT is the fixed delay between the encoding and decoding processes for a transmitted video signal, R(1−m₁) is the minimum instantaneous transmission rate that the communications system achieves at average transmission rate R, and M is the maximum total buffer storage available.

U.S. Pat. No. 5,544,327, entitled LOAD BALANCING IN VIDEO ON DEMAND SERVERS BY ALLOCATING BUFFER TO STREAMS WITH SUCCESSIVELY LARGER BUFFER REQUIREMENTS UNTIL THE BUFFER REQUIREMENTS OF A STREAM CANNOT BE SATISFIED, issued to Dan et al., discloses a buffer manager that balances the loads on various movie storage elements of a video server by preferentially buffering streams on highly loaded elements. The allocation of buffer memory occurs when the storage element load increases due to the arrival of a new request or when buffer space becomes available due to a pause in transmission.

U.S. Pat. No. 5,572,645, entitled BUFFER MANAGEMENT POLICY FOR AN ON DEMAND VIDEO SERVER, issued to Dan et al, discloses a method for reducing the disk bandwidth capacity required by a multimedia server by selectively retaining data blocks that have already been delivered by one data stream. The retained data blocks are then available for reuse by other media applications. Due to stream dependent data block buffering, the storage requirement is less than that required for the buffering of an entire movie because the buffering adapts to changing buffer access patterns.

U.S. Pat. No. 5,179,662, entitled OPTIMIZED I/O BUFFERS HAVING THE ABILITY TO INCREASE OR DECREASE IN SIZE TO MEET SYSTEM REQUIREMENTS, issued to Corrigan et al., discloses a double buffering scheme which writes its data content to auxiliary storage. The size of the buffers is increased until the computer system does not have to synchronously wait for one buffer to complete its write operation before it can refill that buffer with data.

All of these admission control and buffer management systems suffer from idealized assumptions regarding the data stream, or by providing expensive buffer expansion capabilities designed to deal with peak data rates. The admission control protocol is at the core of any video server implementation. Ideally, an admission control system is needed that provides a predictable relationship between the defining characteristics of the video data streams and the buffer requirements.

### SUMMARY OF THE INVENTION

In accordance with principles of the present invention, an admission control system includes a storage device, and a buffer memory interconnected to the storage device. An admission controller, interconnected to the buffer memory, includes means for using parameters pertaining to interactions between the storage device and the buffer memory, and means for controlling data transfers between the storage device and the buffer memory in response to at least some of the parameters being measured.

The system of the present invention permits a video server to have a lower cost per video stream by using the capacity of the mass storage device more effectively. The admission control system described here uses video stream buffer requirements as performance parameters to control the allocation of video streams and video stream bandwidth. A novel admission control algorithm compares the characteristics of the video stream such as bit rate, playback/record and offset, with the buffer requirements, thereby providing a more predictable relationship between the data within the video stream and the resultant buffer usage. An analytical model relates video stream bit rates and disk performance parameters to buffer space requirements, permitting prediction and management of the amount of buffer memory used by a video server during disk transfers.

### BRIEF DESCRIPTION OF THE DRAWINGS

FIG. 1 is a simplified block diagram of a video server utilizing the present invention;

FIG. 2 is a graph depicting buffer usage for a video playback stream;

FIG. 3 is a graph depicting buffer usage for a video recording stream;

FIG. 4 is a graph depicting the experimentally determined relationship between the total buffer requirement and the total bit rate for three playback streams assuming a uniform transfer rate across the disk;

FIG. 5 is a graph depicting the experimentally determined relationship between the total buffer requirement and the total bit rate for four playback streams assuming a uniform transfer rate across the disk;

FIG. 6 is a graph depicting the experimentally determined relationship between the total buffer requirement and the total bit rate for four mixed data streams (Write, Read, Write, Read) assuming a uniform data transfer rate across the disk drive;

FIG. 7 is a graph depicting the experimentally determined relationship between the total buffer requirement and the total bit rate for three recording video streams; and

FIG. 8 illustrates the timeline for one cycle of video stream service.

### DETAILED DESCRIPTION OF THE INVENTION

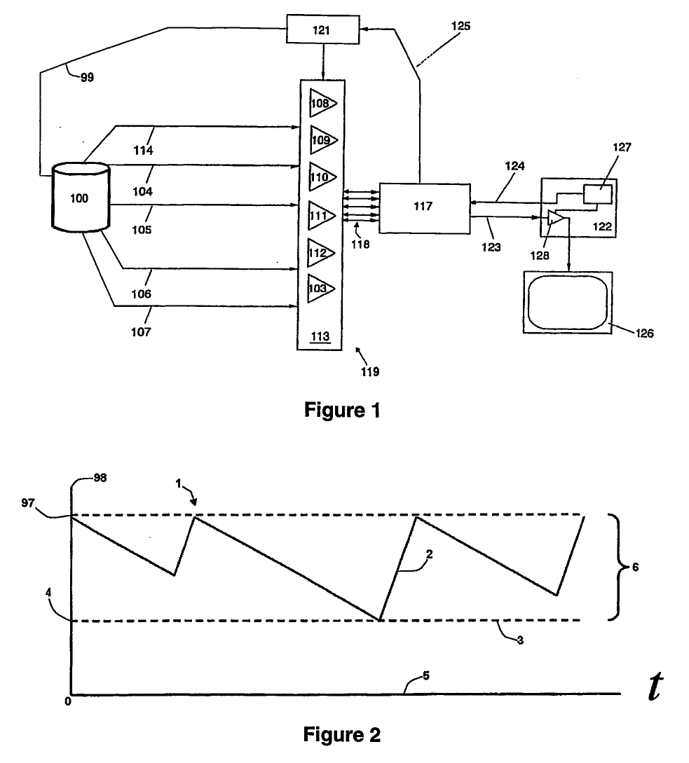

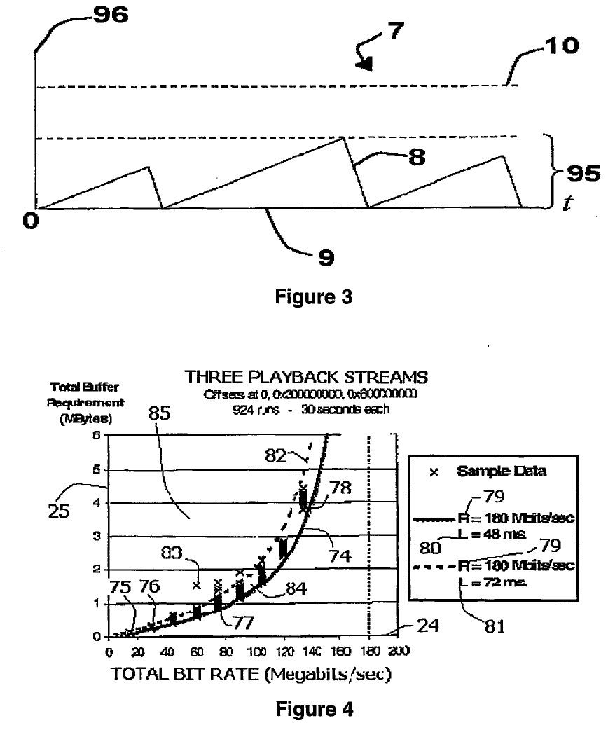

FIG. 1 shows a simplified diagram of a video server 119 incorporating an embodiment of the present invention. The server 119 includes a randomly accessible magnetic disk 100 which stores digital program information representing audio and video signals. This digital information is retrieved from the magnetic disk 100 and transmitted along lines 104, 105, 106, 107 and 114 to buffer memory 113. The buffer memory 113 includes random access memory buffers 103, 108, 109, 110, 111 and 112. Each output of the buffers is linked to telecommunications network 117 via transmission lines 118.

Admission controller 121 is a programmable selecting or switching device adapted to controllably allocate buffer memory 103, 108, etc. to the digital signals retrieved from disk 100 in response to requests from client 122, for example, for access to the digital data contained on disk 100. The network 117 is interconnected to the signal decoder and viewer interface of client 122 via lines 123 and 124. The decoder/interface of client 122 includes an on board processor 127 and a local buffer 128. The decoder/interface of client 122 is connected to a video display 126. The admission controller 121 is linked to the network 117 via line 125 and to the disk 100 via line 99.

The rate at which digital signal information is transmitted to the buffer memory 113 cannot exceed the bandwidth of the combination of the disk 100 and its associated buffer memory links 104-107 and 114. When clients 122 request access to the buffer memory 113, the admission controller 121 determines if there is enough buffer space and disk bandwidth to accommodate the client request and allocates video data streams accordingly.

The present invention creates a model for the disk 100 when it is serving several simultaneous video data streams. The following assumptions are made in creating this model. First, video streams are served in round-robin fashion in cycles or rounds, that is, each video stream receives bytes from the disk 100 once per cycle and the order in which the video streams are serviced is fixed. Second, the buffer 108, 109, 110, etc. associated with each video stream is completely filled (or emptied in the case of recording) whenever that video stream is serviced. Third, data transfer times and rotational latencies are the same from cycle to cycle, and the data transfer rate is the same across the disk, regardless of offset or cylinder position. Finally, the rate of emptying (or filling in the case of recording) of the buffers by the network 117 is continuous, that is, does not vary over time.

The following notation is used:

R is the bit transfer rate of the disk after the disk head is in position, i.e. the burst data transfer rate;

rₓ is the requested data transfer rate for an individual video data stream x;

Iₓ is the disk rotational latency for video stream x;

dₓ is the number of bits removed from the buffer for stream x during one cycle;

T is the time required to complete one cycle.

To maintain the requested data transfer rate rₓ for each video stream x, the number of data bits dₓ transferred to or from the transmission medium during each cycle T, must be:

dₓ=rₓT

The buffer memory, therefore, must allocate dₓ bits to video stream x. Consequently, Σdₓ is the total amount of buffer memory required to process all of the data streams.

In order for the buffer to transfer dₓ bits to or from the transmission medium in a cycle T, those bits must have been transferred from, or be able to be transferred to the disk at the burst data transfer rate R within that cycle T. The actual disk data transfer time for video stream x, thus, is:

$$\frac{{d}_{x}}{R}$$

Referring to FIG. 8, the time line for one cycle of video data stream service for three data streams is illustrated. The interval of time T needed to perform one complete cycle of video stream service is divided into three separate phases, each phase transferring data related to one of the three data streams. One phase 69 includes the time dₐ/R consumed by actually transferring a burst of data from (or to for recording) the disk 100 to the buffer memory 113 for video stream a. Assuming video stream a is associated, for example, with buffer 108 (of FIG. 1), the time period 70 will equal the available space dₐ in buffer 108 divided by the disk data transfer rate R.

The phase 69 also includes the rotational latency period Iₐ during which the head is repositioned and the platter in disk 100 rotates into position to begin the transfer of data to buffer 108. Although illustrated as preceding the disk data transfer, there may be other latency periods which occur throughout the data transfer period 70. In general, to improve disk access, video data associated with a data stream will be stored in known contiguous fashion. However, there will be other latency periods even within transfers of contiguous data: time periods between access of each contiguous block on a cylinder and time periods when switching from one cylinder to the next. These other latency periods are very short compared with the preceding latency period associated with repositioning the disk head and waiting for the rotational latency, and in order to simplify the figure are all subsumed in the illustrated latency period Iₐ.

Another phase 71 is defined by the latency period I_{b} followed by data transfer d_{b}/R to the buffer (buffer 109, for example) associated with video stream b. A third phase 72 includes the latency period I_{c} and the data transfer d_{c}/R associated with video stream c. Once the three phases are complete, the process repeats for video stream a. By the time the cycle is completed, the network 117 has emptied buffer 108 by the constant amount rₐT. Since data transfer and latencies per cycle are assumed to be constant, the following symmetrical relationships define buffer drainage for each video stream:

$${d}_{a} = {r}_{a} ( \frac{{d}_{a}}{R} + {I}_{a} + \frac{{d}_{b}}{R} + {I}_{b} + \frac{{d}_{c}}{R} + {I}_{c} ) ;$$

$${d}_{b} = {r}_{b} ( \frac{{d}_{a}}{R} + {I}_{a} + \frac{{d}_{b}}{R} + {I}_{b} + \frac{{d}_{c}}{R} + {I}_{c} ) ; and$$

$${d}_{c} = {r}_{c} ( \frac{{d}_{a}}{R} + {I}_{a} + \frac{{d}_{b}}{R} + {I}_{b} + \frac{{d}_{c}}{R} + {I}_{c} )$$

This system of three linear equations for dₐ, d_{b} and d_{c} may be solved symbolically using Cramer's rule to obtain:

$${d}_{a} = \frac{{r}_{a} ( {I}_{a} + {I}_{b} + {I}_{c} )}{1 - ( \frac{{r}_{a}}{R} + \frac{{r}_{b}}{R} + \frac{{r}_{c}}{R} )} ;$$

$${d}_{b} = \frac{{r}_{b} ( {I}_{a} + {I}_{b} + {I}_{c} )}{1 - ( \frac{{r}_{a}}{R} + \frac{{r}_{b}}{R} + \frac{{r}_{c}}{R} )} ; and$$

$${d}_{c} = \frac{{r}_{c} ( {I}_{a} + {I}_{b} + {I}_{c} )}{1 - ( \frac{{r}_{a}}{R} + \frac{{r}_{b}}{R} + \frac{{r}_{c}}{R} )}$$

This pattern is true for any number of data streams. Thus, in general,

$${d}_{x} = {r}_{x} ( \frac{\sum {I}_{y}}{1 - \sum \frac{{r}_{y}}{R}} )$$

The total buffer requirement Bₓ for the buffer associated with video stream x is therefore

$${B}_{x} = \sum {d}_{x} = \sum {r}_{x} ( \frac{\sum {I}_{y}}{1 - \sum \frac{{r}_{y}}{R}} ) \qquad ( Equation 1 )$$

Assuming that the data transfer rate at the disk cylinder containing data for video stream x is Rₓ, the amount of buffer drainage can be expressed as

$${d}_{x} = {r}_{x} ( \frac{\sum {I}_{y}}{1 - \sum \frac{{r}_{y}}{{R}_{y}}} )$$

and the total buffer requirement is

$${B}_{x} = \sum {d}_{x} = \sum {r}_{x} ( \frac{\sum {I}_{y}}{1 - \sum \frac{{r}_{y}}{{R}_{y}}} )$$

Assuming a uniform transfer rate across disk 100 and utilizing Equation 1 (above), if

Bₐₗₗ=dₐₗₗ=Σdₓ, rₐₗₗ=Σrₓ, and L=Σl_{y},

Equation 1 can be rewritten as

$${B}_{all} = {d}_{all} = {r}_{all} L ( \frac{1}{1 - \frac{{r}_{all}}{R}} ) \qquad ( Equation 2 )$$

In Equation 2, Ball is the total buffer memory required to successfully transmit the data streams between the disk drive and the transmission medium. The values of R and L are dependent on the operation of disk 100. The parameter r is the requested constant data rate for data transmitted over the transmission medium. The parameter R may be estimated using the program ‘transfer( )’ described above and the latency L may be estimated using an average latency of one half of the rotational period of the disk platters. For example, values of R typically reside between 120 and 210 Megabits/sec, and values of L depends on the rotational speed of the disk 100.

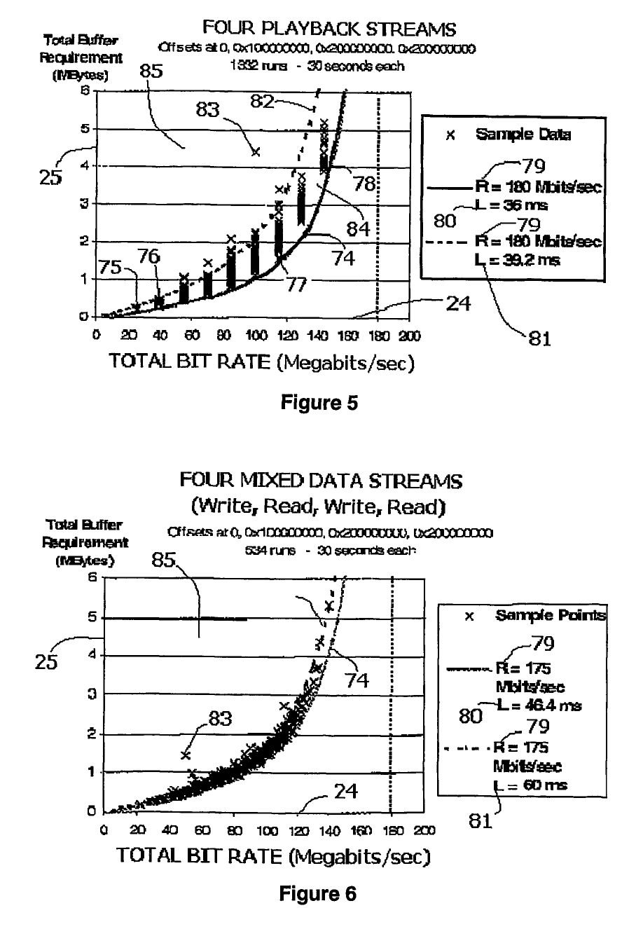

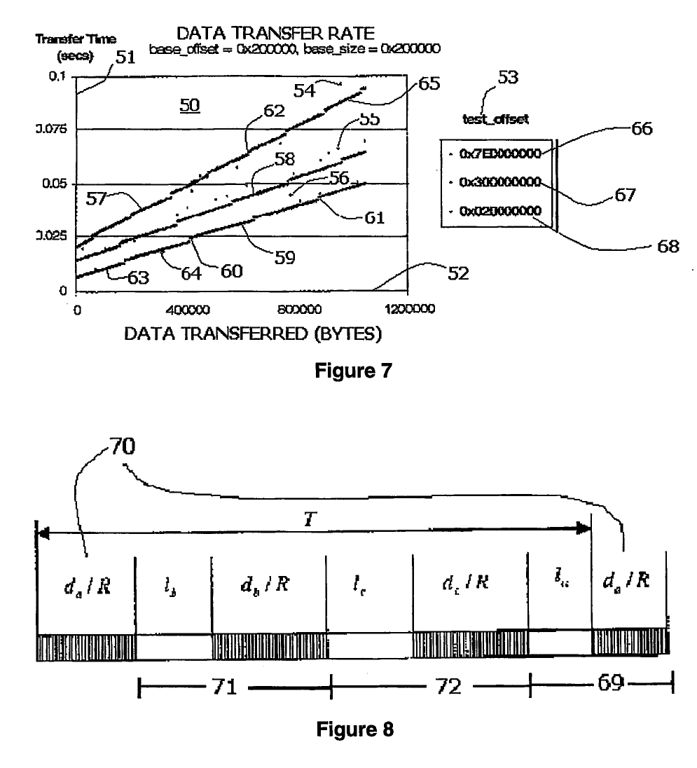

Equation 2 may be used to select disk drives 100 having appropriate operational parameters for use in a multimedia transmission system. Referring to FIGS. 4-6, one method of selecting disks having desired values of R and L is to examine the relationship between the total buffer requirement 25 and the total bit rate 24. Initially first values 79 and 80 of R and L, respectively, are selected so that curve 74 represents the lower bound of actual data points 75, 76, 77, 78, etc. The value 79 of R is then kept fixed and a second value 81 of L is selected in order to produce a curve 82 which excludes all but a few outlying data points 83. The second curve 82 defines the desired behavior of admission controller 121.

When a request is received by the admission control circuit 121 (of FIG. 1) from the network 117 via line 125 to add a new data stream at a desired constant transmission medium data rate r. The admission control circuit 121 recalculates Equation 2 including the current data streams and the new data stream at the requested data rate r and using the disk drive parameters estimated in the manner described above. The newly calculated buffer size Bₐₗₗ is then compared to the total available buffer memory 113 size. If the newly calculated buffer size Bₐₗₗ is less than the total buffer memory 113 size, then there is sufficient buffer memory 113 space to successfully transmit the newly requested data stream and that data stream is admitted. If the newly calculated buffer size Bₐₗₗ is greater than the total buffer memory 1 13 size, then there is not sufficient buffer memory 113 space to successfully transmit the newly requested data stream and that data stream is not admitted.

If a proposed combination of video streams 104, 105, 106, etc. produces a data point lying in region 84 beneath curve 82, the video server system 119 can support the transmission and reception of those data streams. If the resulting data point resides in region 85 above curve 82, then the server system 119 will not be able to support the transmission of those data streams. The total amount of buffer space 113 used by server 119 to accomplish disk transfer is a configurable but limited resource. The admission controller 121 determines if the server 119 is capable of processing the video streams being presented for transmission, and if so, those streams may be served without interruption.

The invention has been described above in the context of a multimedia system. However, one skilled in the art will understand that any data transmission system which records data on a mass storage device, or retrieves previously recorded data from a mass storage device may incorporate an admission control system in accordance with the present invention.

1. An admission control system comprising:
a storage device;
a buffer memory, coupled to the storage device; and
an admission controller, coupled to the buffer memory and the storage device, the admission controller comprising:
means for determining parameters pertaining to interactions between the storage device and the buffer memory; and
means for controlling data transfers between the storage device and the buffer memory in response to at least some of the parameters.

2. The admission control system of claim 1, further comprising a transmission medium wherein the buffer memory is coupled between the storage device and the transmission medium; wherein the admission controller further comprises:
means for determining a first parameter being a burst rate at which data is capable of being transferred by the storage device; and
means for determining a data transfer rate required by each of one or more streams of data to be transferred between the storage device and the transmission medium, thereby determining a relationship between the required data transfer rate to an available burst data transfer rate.

3. The admission control system of claim 2, wherein the admission controller further comprises:
means for determining a second parameter being a delay encountered by the storage device in accessing data associated with a second one of the one or more data streams after transferring data associated with a first one of the one or more data streams; and
means for calculating a total of delays attributable to all of the one or more data streams.

4. The admission control system of claim 3, wherein the admission controller further comprises:
means for determining a quantity of data transferred between the buffer memory and the storage device attributable to each data stream: and
means for calculating a total time required for all data streams to transfer a first increment of data to the buffer memory before any data stream transfers a second increment of data to the buffer memory, thereby calculating a service cycle.

5. The admission control system of claim 4, wherein the buffer memory comprises a total amount of buffer memory space partitioned into a plurality of individual buffer memories, each buffer memory storing data associated with an individual data stream being transferred between the storage device and the buffer memory.

6. The admission control system of claim 5, wherein the storage device is a magnetic disk.

7. The admission controls system of claim 6, wherein the means for determining a delay encountered by the storage device in locating data associated with a second data stream after transferring data associated with a first data stream determines rotational latency of the magnetic disk.

8. The admission control system of claim 7, wherein the admission controller further comprises:
means for calculating the total amount of buffer memory space utilized during a service cycle; and
means for preventing transfer of data between the buffer memory and the magnetic disk that exceeds the total amount of buffer memory utilized during a service cycle.

9. The admission control system of claim 8, wherein the admission controller causes the ratio of the required data transfer rate to the available data transfer rate to be less than one.

10. A device for regulating access to a buffer memory by a storage device transferring multiple data streams to and from respectively corresponding portions of the buffer memory, comprising an admission controller interconnected to the buffer memory and the storage device, the admission controller determining a plurality of parameters relating to characteristics of the buffer memory and the storage device, the admission controller regulating access to the buffer memory by each data stream in response to the parameters.

11. The device of claim 10, wherein the admission controller substantially exhausts the memory capacity of the portion of the buffer memory corresponding to a first data stream before transferring data corresponding to a subsequent data stream, the admission controller transferring at least some data from each data stream in order to complete one service cycle.

12. The device of claim 11, wherein the admission controller uses at least one of the parameters:
R, where R is a burst data transfer rate of the storage device;
rₓ, where rₓ is a relatively constant data transfer rate required by data stream x;
lₓ, where lₓ is a data transfer delay inherent in the storage device due to a time required to stop transferring data from a preceding data stream and to start transferring data from the data stream x;
dₓ, where dₓ is a quantity of buffer memory utilized by data stream x during one service cycle; and
T, where T is an elapsed time for one complete service cycle.

13. The device of claim 12 wherein the admission controller receives a request to include a new data stream having a corresponding data transfer rate and determines on the basis of at least some of the parameters whether to admit that data stream into the plurality of data streams being transferred.

14. The device of claim 13 wherein the admission controller calculates the total amount of buffer memory required to transfer the plurality of data streams and the new data stream and compares the required buffer memory to the available buffer memory and admits the new data stream if the available buffer memory is greater than the required buffer memory and does not admit the new data stream otherwise.

15. The device of claim 12, wherein the admission controller includes means for creating a plurality of summed values, the summed values including at least one of the summed values:
dₐₗₗ, where dₐₗₗ is a total quantity of buffer memory utilized by all data streams during one service cycle;
rₐₗₗ, where rₐₗₗ is a data transfer rate required by all data streams; and
L, where L is a total delay due to an elapsed time required to stop transferring data from each data stream and to start transferring data a next data stream.

16. The device of claim 15, wherein the admission controller includes means for selecting a storage device having respective values for R and L that optimizes the data rate for transfers of data between the storage device and the buffer memory.

17. A method for transferring a plurality of data streams at respective corresponding transfer rates, comprising:
determining a plurality of parameters relating to a buffer memory having a maximum capacity and a disk storage device having a burst transfer rate;
transferring data between the disk storage device and the buffer memory in bursts at the burst transfer rate of the disk storage device and transferring data to and from the buffer memory at the respective transfer rates corresponding to each of the plurality of data streams
calculating a total amount of buffer memory required to transfer all of the data streams; and
controlling access to the buffer memory by the data streams such that the total required buffer memory does not exceed the maximum capacity of the buffer memory.

18. The method of claim 17, wherein the step of determining parameters relating to disk storage includes determining a disk data transfer rate and a delay attributable to locating data attributable to transferring data from one data stream after data has been transferred from a previous data stream.

19. The method of claim 18, further comprising the steps of:
transferring data attributable to a first data stream to a first buffer memory until the first buffer memory is substantially filled; and
transferring data attributable to a second data stream to a second buffer memory until the second buffer memory is substantially filled.
